(19) United States
(12) Patent Application Publication
(10) Pub. No.: US 2003/0031769 A1
(43) Pub. Date: Feb. 13, 2003

(54) Modified atmosphere package and methods

(76) Inventors: Ihor Wyslotsky, Chicago, IL (US); Roman Forowycz, Chicago, IL (US); John Repp, Naperville, IL (US); George Golota, Glenview, IL (US); Bohdan Wyslotsky, Carpentersville, IL (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/921,361

(22) Filed: Aug. 2, 2001

(51) Int. Cl. A23B 4/00

(52) U.S. Cl. 426/397

(57) ABSTRACT

The present invention is directed to an oxygen-level controlled, modified atmosphere package consisting of a cup and a lid in the form of a dome. The cup and the dome are hermetically sealed along the flange of the cup and the dome. The interior of the package is designed to contain food and other perishable components having certain metabolizing characteristics. The package polymers are selected to provide an optimum environment for preserving the freshness of foods packaged in a modified gas atmosphere sealed inside the package with the food. The invention incorporates various mechanically enhanced characteristics, as well as offering enhanced safety with package tamper evidence visible to the consumer. In particular, the invention hereof further incorporates methodology and structures to produce reduced oxygen packaging (ROP) with the interior headspace automatically regulated to a specific partial pressure of oxygen designed to inhibit the growth of anaerobic pathogens.

### BACKGROUND OF THE INVENTION

The present invention relates generally to food containers and more particularly to new methodology and structures for regulating the partial gas pressure of oxygen within a hermetically sealed food container thereby to inhibit growth of anaerobic pathogens while keeping the food fresh.

The packaging system embodied in the present invention also meets the demand for serving “fast food” for the convenience of the consumer. Currently, “fast foods” include such items hamburgers, sandwiches, tacos, burritos, etc. There is a significant need to prepare these and other food items centrally to meet the requisites of both economy and food safety criteria.

Also, individual salad servings, fruit, and other foods are currently prepared at non-centrally located facilities (i.e., retail outlets). They are relatively expensive and are done with limited microbiological control features, if any. Indeed, and for the most part, only centrally processed foods can provide standardized and controlled quality improvements and safety. Moreover, better food safety control includes monitoring of the microbiological aspects, personnel hygiene and lot identification. All these food safety aspects are far better served in a central, large scale manufacturing facility.

Fundamental to the beneficial goal of providing both safety and continued freshness for a packaged food product is control of the atmosphere within the package. In particular, the level of oxygen within the container is of great importance in carrying out these goals. Thus, the structures and methods of the present invention are particularly directed to control of such gaseous elements within such food packages by controlling the diffusion rate of gases into and from such food package. Controlled low oxygen diffusion rates are particularly appropriate for various prepared food products which are susceptible to Clostridium botulinum, whereas high oxygen diffusion rates are appropriate for metabolizing fresh fruits and vegetables.

Thus, the invention embodied herein offers better economies and safety for single portion “fast food” servings which are produced and packaged from a central source, but which have the appearance and qualities of a freshly made “in-store” servings.

### SUMMARY OF THE INVENTION

The present invention is directed to an oxygen-level controlled, modified atmosphere package consisting of a cup and a lid preferably in the form of a dome. The cup and the dome are hermetically sealed along the flange of the cup and the dome. The interior of the package is designed to contain food and other perishable components having defined metabolizing characteristics. The package polymers and the package surface configuration are controlled to provide a selected environment for preserving the freshness of foods packaged in a modified gas atmosphere sealed inside the package with the food. The invention incorporates various mechanically enhanced characteristics, as well as offering enhanced safety with package tamper evidence visible to the consumer.

In particular, the invention hereof further incorporates methodology and structures to produce low oxygen packaging with the interior headspace automatically regulated to a specific partial pressure of oxygen designed to inhibit the growth of anaerobic pathogens and to dispose of undesirable gases such as ethylene and other metabolites.

### BRIEF DESCRIPTION OF THE DRAWING

FIGS. 1a and 1b are perspective views of two (2) preferred embodiments of the gas flushed breathable package of the present invention depicting alternatively a strip seal or a peel seal.

FIG. 2a is a side view of a package of the present invention and FIG. 2b is a detailed view of the designated portion of FIG. 2a showing the spring action of the attached lid.

FIG. 3a is a side view of an alternative embodiment of the package of the present invention. FIGS. 3b-3d are cross-sectional views of portions of the package depicted in FIG. 3a. FIG. 3e is a top view of the lid or dome of the package structure depicted in FIG. 3a.

FIG. 4 is a top view of an alternative embodiment of the lid or dome of the present invention.

FIG. 5a is a side view of a yet further alternative embodiment of the package of the present invention showing a flat top. FIG. 5b is a top view of the flat lid of the embodiment of the package depicted in FIG. 5a.

FIG. 6a is a side view of an alternative embodiment of the lid or dome of the present invention. FIG. 6b is a top view of the lid embodiment depicted in FIG. 6a. FIG. 6c is an enlarged cross-sectional view of the lid depicted in FIG. 6b taken along lines 6c—6c. FIG. 6d is a cross-sectional view of the lid depicted in FIG. 6b taken along lines 6—d, and showing details of the modification of rib configurations to match the required oxygen diffusion.

FIGS. 7a and b are charts showing the oxygen and carbon dioxide levels for days 0-16 for two different gas mixtures as used in the modified atmosphere package of the present invention.

FIG. 8 is a top view of a further lid structure showing alternative sealing mechanisms.

FIG. 9 is a top view of a further lid structure showing alternative sealing and package opening means and mechanisms.

FIG. 10a is a side view of a yet further additional embodiment of the package of the present invention showing the use of a label with micropores disposed therein. FIG. 10b is an enlarged detailed view of the designated portion of such package embodiment as show in FIG. 10a.

FIG. 11 is a chart showing the rate of oxygen diffusion into the package of the present invention for micropore sizes 10 microns, 15 microns and 25 microns, respectively.

FIG. 12 is a yet different embodiment of the package of the present invention showing an alternative bottom structure.

### DETAILED DESCRIPTION OF PREFERRED EMBODIMENTS

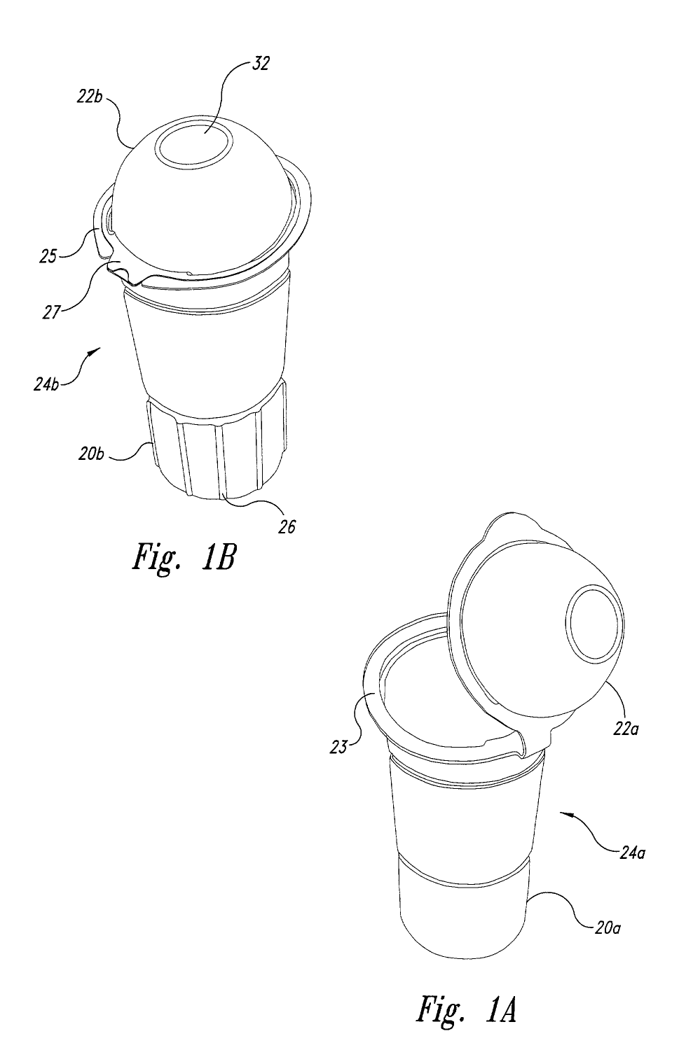

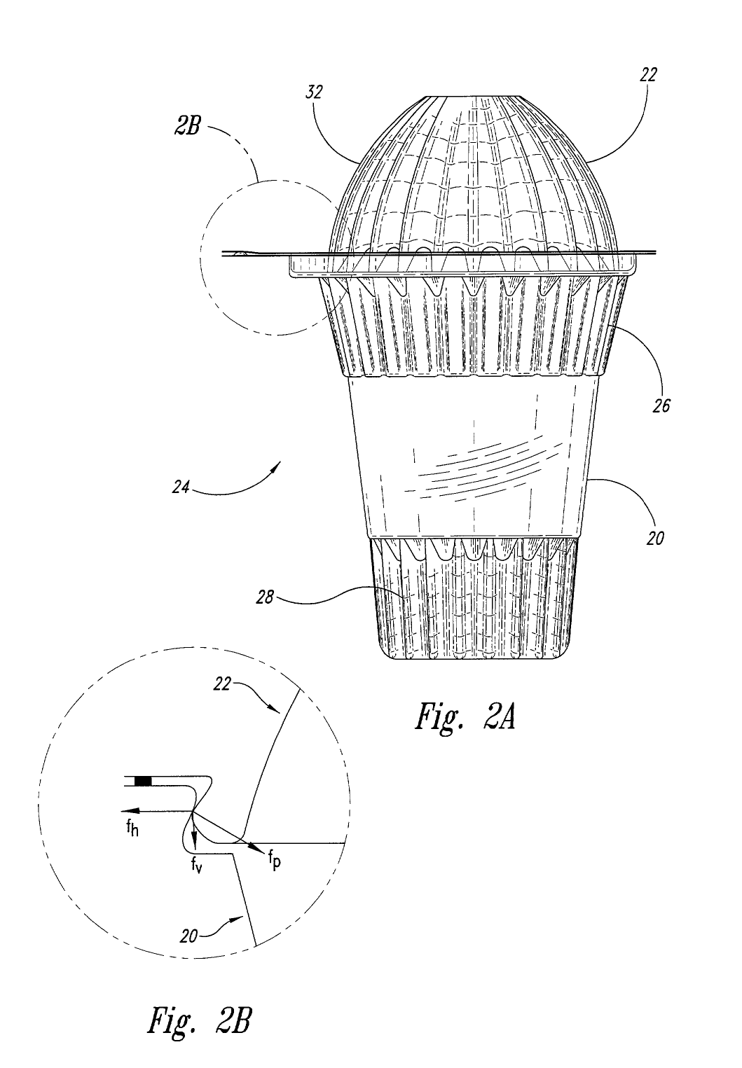

As set forth in FIGS. 1 and 2 in particular, the hermetically sealed lid or dome 22 and the container portion or cup 20 of the package generally 24 of the present invention may be equipped with a variety of optional package-opening features. As shown in FIGS. 1a and 1b, the dome 22a and 22b can preferably be lifted away from the cup 20a and 20b, either (a) by peeling seal 23 directly away from the cup (as shown at container 24a), or (b) by equipping the lid flange 25 of container 24b with a removable seal 27. (See FIG. 1). The seal 23 of such first embodiment 24a is made by fusing the peelable polyolefin sealant layers which have been laminated to the surfaces of the rigid polymers of the cup 20a and the dome 22a. The peelable seal strength is adjusted by changing the ratios of the polybutelene and ethyl vinyl acetate modifiers in the conventional polyolefin sealant matrix.

Also as set forth in FIGS. 1 and 2 hereof, the construction of cup 20 and dome 22 as elements of the package (generally 24) include the selection of polymers according to the food to be packaged. Cup 20 also includes the design of the functional ribs 26, and in some embodiments agitator ribs 28, as shown in FIG. 2 hereof, to assist in the blending of the components such as salad dressing, etc. The selection of polymers for packaging relatively stable foods (such as cooked meals, meats, cooked vegetables and fruits, baked goods and desserts) includes high barrier laminated materials such as polyvinyl chloride, and polyethylene teraphalate. Each one of these materials is laminated with an ethyl vinyl acetate tie layer with ethyl vinyl alcohol interlayer and an additional layer of peelable sealant consisting of modified polyolefin. Such structures offer low gas diffusion, which is required for maintaining the freshness of cooked and baked products. The typical oxygen diffusion of the materials employed here is 0.1 cc/100 in²/24 hours/ATM @ 75° F. and RH (relative humidity) of 65%.

As shown in FIG. 2, the two halves of the package 24 (i.e., the dome 22 and the cup 20) may also be held together by the spring action of the attached lid 22, which is being pressed down toward the flange 25 of the cup 20. In these embodiments, and as shown in FIG. 2, the rim 29 of the lid 22 collapses inwardly when inserted into the female rim comprising flange 25 on the cup 20. When the rim 29 of the dome or lid snaps into the nesting position of the cup 20, the oversized dimension of the dome rim 29 causes force (fₚ) against the corresponding rim 25 on the cup 20. The two components of pressure fₚ are horizontal force fₕ and vertical component fᵥ. Thus, the fᵥ force holds the two components of the package 24 together while the seal itself provides hermetic closure. The force as shown in FIG. 2b is a result of the structural elements of the present invention, and such force functions to pull the structures of the dome against the corresponding structures of the cup. This allows the use of low peel force sealants which in turn permits the use of relatively low peeling forces in separating the dome from the cup. Also, the force engaging the cup with the dome further protects the structure from separation during handling.

The selection of the structures for still metabolizing products (such as fresh vegetables, fresh cut fruits and other products) is based on the requirements for diffusion control of oxygen into package 24, with the objective of maintaining a lower metabolic rate, while eliminating from the package the evolving carbon dioxide gas, ethylene gas, aromatic metabolites, ethanol gas, acetaldehyde and other gaseous products of metabolism. Since all vegetables and fruits metabolize at different rates, the polymers for the package are selected accordingly. The gas exchange is directly proportional to container wall area. The process of gas diffusion through the polymer wall of the container, is also adjusted by the design of ribs 26 of package 24, according to the following equation.

Diffusion=a/t

where:

a=area

t=polymer thickness

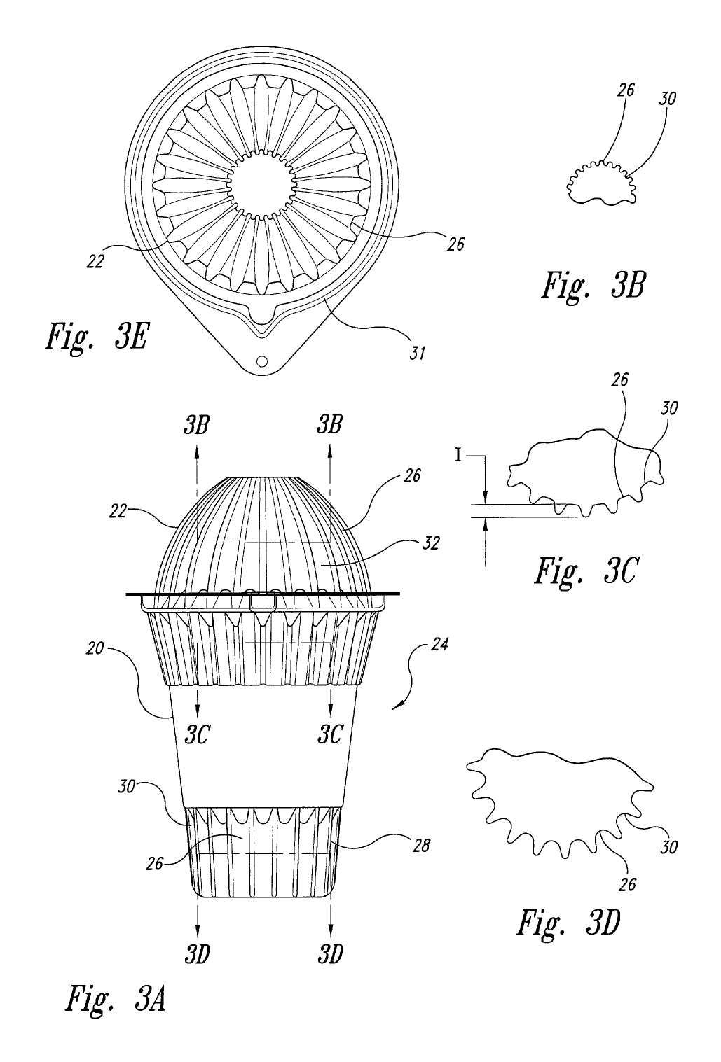

By increasing the depth and number of the ribs 26, it is possible to increase the total area of the walls 30 of package 24, as shown particularly in FIGS. 3b, 3c, and 3d, thus increasing the rate at which the oxygen can diffuse into the package having a defined headspace 32 (i.e., internal gas volume), as shown in FIGS. 1, 2, and 3. With this technique, the desired supply of oxygen for a particular food item can be obtained.

The described technique to adjust gaseous diffusion into and out of container 24 simplifies the process of selecting the required diffusion characteristics based on the polymer type and the gauge (thickness) used for each specified food application.

As shown for example in FIG. 3, the hand held fast food container 24 hereof is preferably manufactured by a solventless laminating and thermoforming process (for example, see U.S. Pat. No. 5,632,133) in line with the packaging machine depicted and described therein. Packaging machines of this type laminate the rigid polymer with the peelable sealant film, and thereafter thermoform the cups into which the green lettuce, salad additives and/or other food products are to be loaded. The machine then applies the pre-made dome or lid 22 to each filled cup or container portion 20. After the lidding operation, the air is displaced from the container and is replaced with a mixture of gas consisting in alternative embodiments of (a) oxygen and nitrogen, (b) oxygen, nitrogen and carbon dioxide, or (c) another suitable gas. The lid 22 is then sealed to the cup 20, the package 24 is cut out of the web (not shown herein) and dispensed out of the machine in sequence release.

The package embodiment of FIG. 3 may be sized to contain a single service portion of popular types of leafy salads. Since various vegetables and fruits exhibit different metabolic rates, the polymers used must provide for the required respiration. Additionally, providing ribs 26 in the walls 30 increases the surface area of package 24. One function of the ribs is to reinforce walls 30 of the container 20 making package 24 more rigid, while simultaneously increasing the surface area of package 24, and perhaps, while also reducing the average thickness of walls 30. The increase in the surface area of the container 20 and the consequent reduction of the average wall thickness adapts itself to the diffusion of oxygen into container 24. Thus, the sizing of ribs 26 functions to change the surface area of package 24. These surface area changes alter the total diffusion of the oxygen into container 20. Since the metabolic rates of various vegetables and fruits are different, the developed technique of rib 26 design is selectively used to adjust to the metabolic rate for each type of vegetable or fruit (or other food product) being packaged without having to resort to a large number of diverse polymeric materials. Also, changing the rib component of the forming mold changes the rib configuration on the packaging machine.

As one example, container 20 is configured to match the metabolic rate of 4 oz. of mixed lettuce salad at 1.0% to 2.5% partial pressure of oxygen at a storage temperature of 35° to 42° F. The matched diffusion is provided (a) by using the appropriate type of polymer, and (b) by providing the necessary package surface area.

Polymers used for thermoforming cups suitable for such use may comprise a laminate of clear or pigmented styrene-butadiene copolymer fused with a coextruded, clear polyolefin sealant modified with polybuteline and ethyl vinyl acetate tie layer for peelability of seals. The joining of the styrene-butadiene copolymer sheet is achieved utilizing a system covered by U.S. Pat. No. 5,632,133.

The overall thickness of the sheet for such a cup is in some embodiments 1000 microns, and the thickness of the polymer sheet for the dome portion of some embodiments is 450 micron thick.

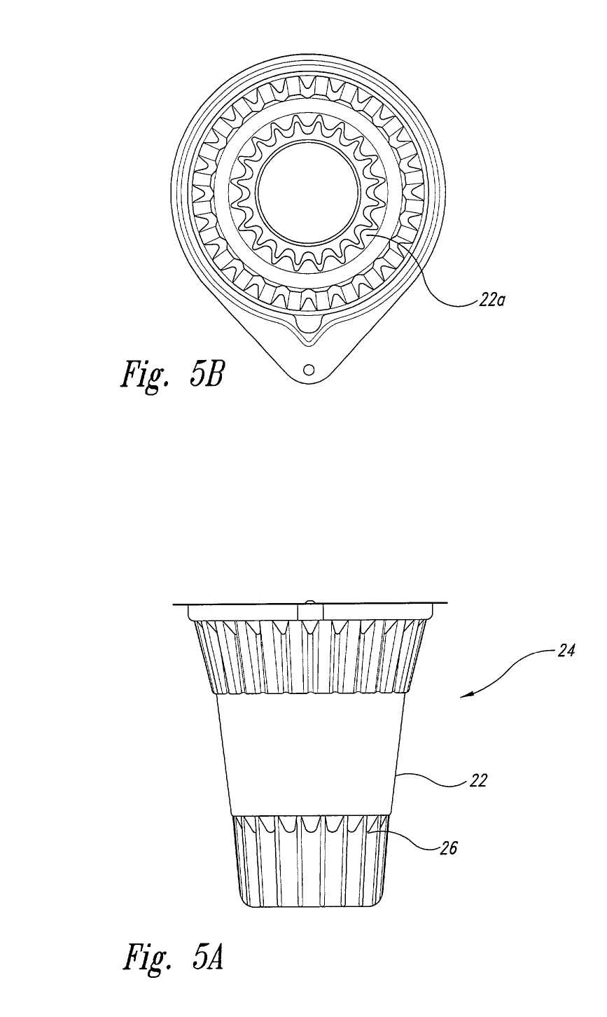

As shown also in the modified embodiment of FIG. 5, for example, the diffusion of the oxygen through a 1000 micron thick laminated sheet for forming is: 16.5 cc O₂/24 hours/100 in²/ATM. During thermoforming, the 1000 micron sheet undergoes 4.83 times thickness reduction. Additionally, due to the polymer orientation during forming, the diffusion improvement is not proportional, and the corresponding diffusion of O₂ improves only by a factor of 4.4. Hence, the diffusion of oxygen through the walls of the cup with a total surface of 74.6 in² is:

Cup O₂ diffusion=16.5 cc×4.4×74.6 in²/100 in²=54.16 cc/24 hours/ATM

As shown in FIG. 6, the diffusion of the oxygen through a 450 micron thick laminated sheet is: 34.8 cc O₂ 24 hours/100 in² ATM. During thermoforming, the 450 micron thick sheet undergoes 2 times thickness reduction. Again and due to polymer orientation during forming, the diffusion of oxygen is not proportional to the thickness reduction. The corresponding diffusion of oxygen improves only by a factor of 1.7. Thus, the diffusion of oxygen through the dome of a surface area of 32.6 in² is:

Dome O₂ diffusion=34.8 cc×1.7×32.6 in/100 in²=19.29 cc/24 hours/ATM

Accordingly, the O₂ diffusion of such a salad-on-the-go container is found to be: 73.48 cc/24 hours/ATM at 35° to 40° F. storage.

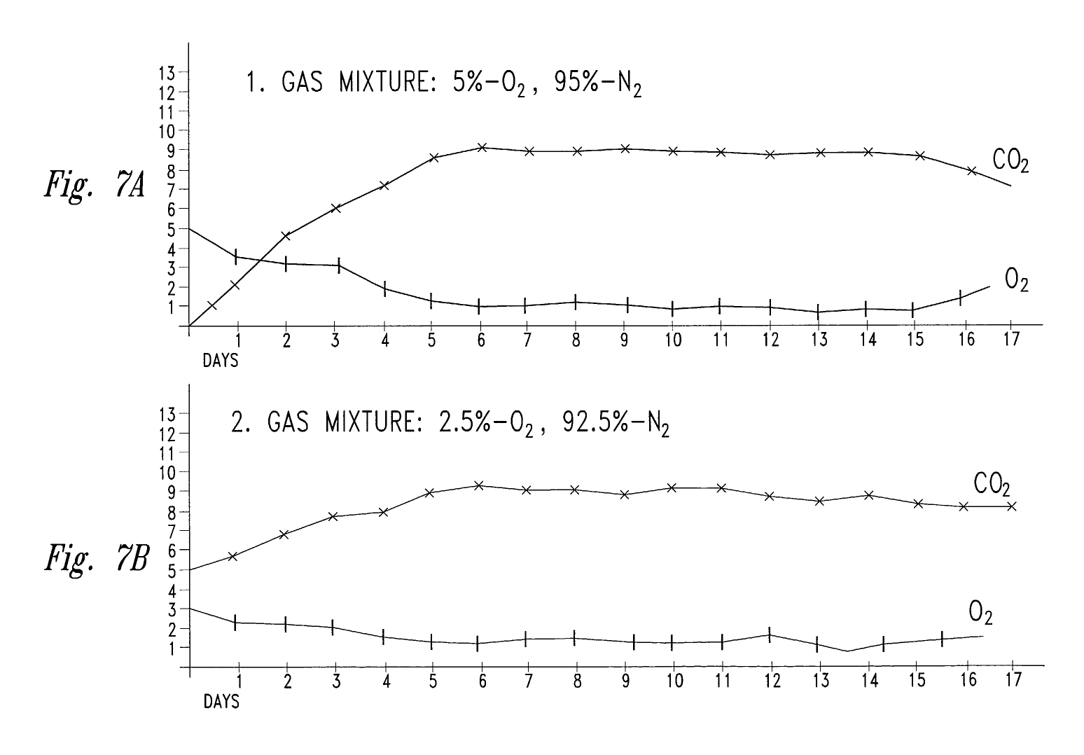

As shown in FIG. 7, for two different gaseous mixtures, the diffusion of oxygen for a 4 oz. mixed lettuce salad at storage temperature reaches equilibrium without totally depleting the oxygen from the package, thus maintaining the product freshness over an extended period of time of 14 to 21 days. In such representative embodiments, the commercially available rigid polymers for making small containers have diffusion of oxygen and other gases which is below the diffusion rate necessary to preserve the freshness characteristics of metabolically active products such as fresh vegetables and fruits. Until the provision of the present invention, the industry has used a rigid container in a shape of a large bowl, not a cup with a thin web lid sealed to the rigid container. Since the thin web cannot diffuse the necessary quantity of oxygen through a small area of the cup lid, the diffusion through the walls of the cup as described in the present embodiment allows for the use of a thin web in small lid area of the cup. The oxygen diffusion of such thin films and the cup provides sufficient oxygen diffusion into the package to maintain the product's freshness.

In the present invention, surface area enlargement by means of incorporating ribs achieves the necessary diffusion and transmission of oxygen through the walls of the package and thus maintains the freshness of the products.

Additionally, these inventive ribs of the container of the present invention may also be disposed in a manner as agitators to assist in the blending of the dressing and other salad-on-the-go components with lettuce or other solid components.

In some preferred embodiments, the package contains the lettuce and small packets of additives to the salad such as the dressing, croutons and condiments. The consumer purchases the single serve package and opens it by removing the tamper evident seal. The small packages with salad additives are then removed and the contents poured onto the salad. The dome is then snapped back onto the cup. The salad may then be mixed by shaking the package with the contents dispersing for uniform distribution. The ribs, during shaking, help to disperse the added components uniformly. Specifically, the ribs function to stop the rotation of the lettuce around the periphery, while the center of the product can move freely which provides for a differential motion needed for mixing.

In the case of a low O₂ diffusion container the fresh vegetables and fruits also may be improved in shelf life characteristics if not disposed therein to touch the walls of the package. In an oxygen non-diffusing cup with a diffusing lid, the metabolizing food items adhering to the walls would not receive the necessary supply of oxygen. It is therefore a feature of the present invention that the rigid non-diffusing cup for packaging vegetables, when equipped with product spacing ribs, does improve the shelf life of the metabolizing fruits and vegetables.

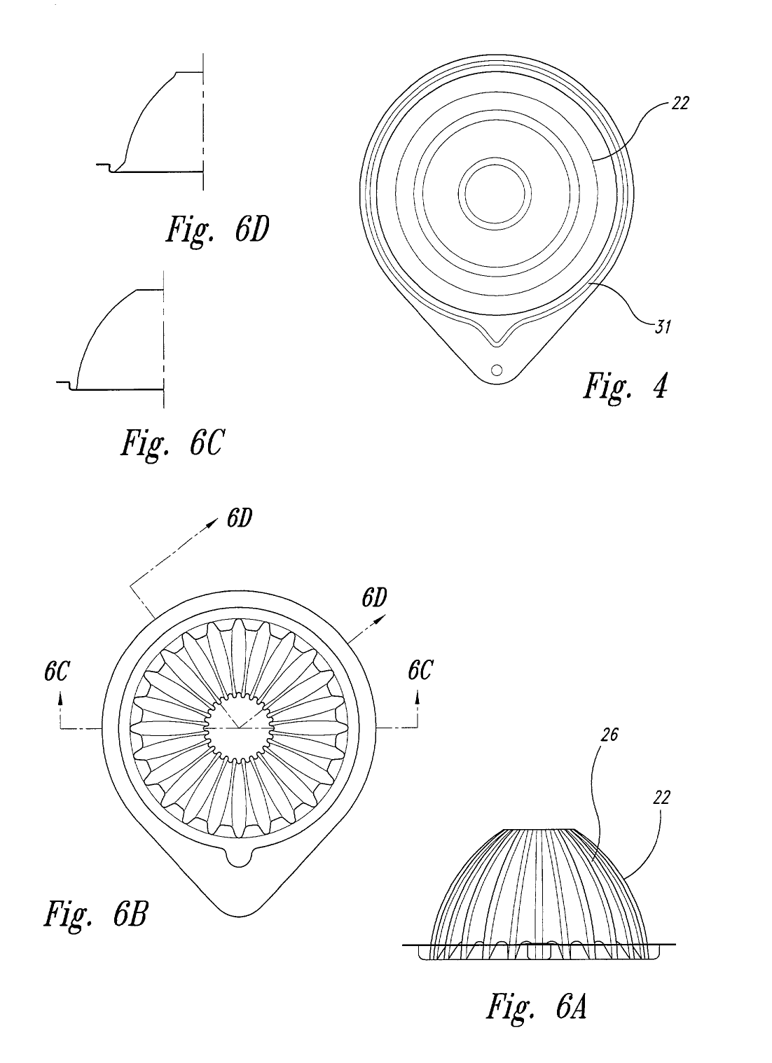

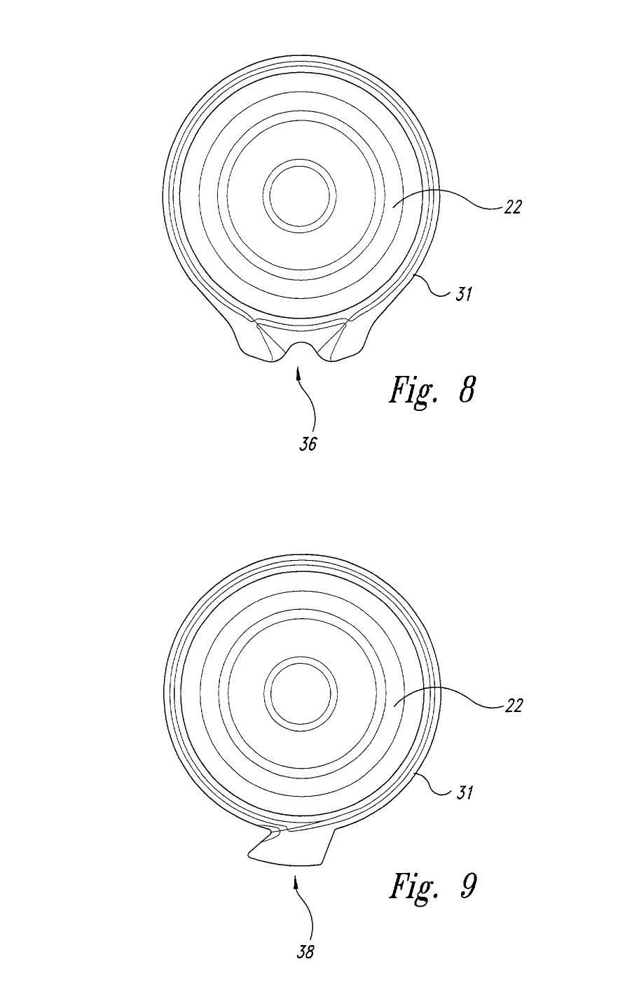

The two opening methods of the package, the peelable seal lid as shown in FIG. 4, and the two versions of the strippable seal opening, generally 36, 38, as shown in FIGS. 8 and 9, are tamper evident for the consumers' safety. Seal 31 is shown in various configurations in these embodiments.

One preferred embodiment of the packages of the present invention includes a cylindrical cup bottom of 2-½ inches in diameter. The feature permits the cup to be placed in convenient cup openings or cup holders in the consoles of cars, furniture, serving trays and other locations.

Five-inch deep drawn cups may be made from a laminated structure with a polyolefin sealing component on the inside surface of the cup and on the upper surface of the flange mating and hermetically sealing with the corresponding flange with compatible sealing layer on the dome.

The walls of such five-inch or more deep drawn cups may be formed from a laminated structure comprised of styrene-butadiene copolymer laminated and fused thermally with an ethyl vinyl acetate base tie layer and modified low density polyethylene sealant, all forming a low barrier structure with high gas diffusion.

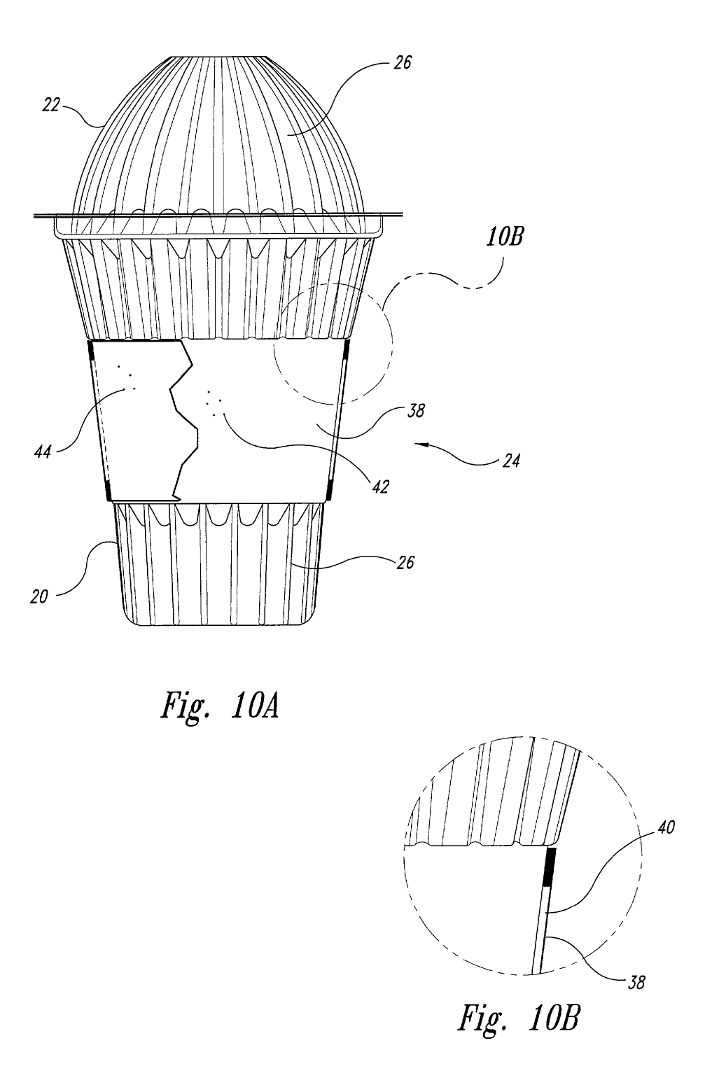

FIGS. 10a and 10b show another variation of control product metabolism for the purpose of extending the useful shelf life of the product being packaged. This embodiment offers the freedom to use any thermoformable polymer with high or low diffusion (transmission) rate of gases into the package and to provide a controlled supply of oxygen into the package.

In these embodiments of the present invention, the metabolic gases diffuse through a label 38, which is adhered to cup portion 20 along its edges. These gases pass freely through the porous label 38 and into the space 40 between label 38 and wall 30 of cup 20. The micro holes 42 of approximately 25 micron diameter in wall 30 of cup 20 allow oxygen to enter package 24. The number of the holes 42 regulates the amount of oxygen allowed to enter the package. Also, these micro holes 42 allow for the carbon dioxide gas and other metabolites to escape the package, similar to the diffusion system through the walls of the polymeric cup and dome.

The material for label 38 can be conventional paper with pores 44 not greater than approximately 0.5 micron diameter, made of high O₂ diffusion expanded polypropylene or expanded polyethylene, all with pores 44 smaller than about 0.5 micron diameter, and which are used as standard label components. This is to prevent microorganism contaminants penetrating the space between the label and the body of the cup, and subsequently penetrating the package.

The container, as shown for example in FIGS. 10a and 10b, has a volume of 750 cc. The oxygen content if the package at 20.9% O₂ in the atmosphere is thus 156.75 cc. The various micro sized pin holes transmit oxygen into the package according to the following table:

| | Per Day Each | | | |
|---|---|---|---|---|
| Micro Hole Size | Day 1 | Day 2 | Day 3 | Day 4 |
| 25 micron | 72.00 cc | 38.25 cc | 26.25 cc | 24.37 cc |
| 15 micron | 39.75 cc | 30.00 cc | 24.00 cc | 21.00 cc |
| 10 micron | 26.25 cc | 23.25 cc | 20.25 cc | 19.00 cc |

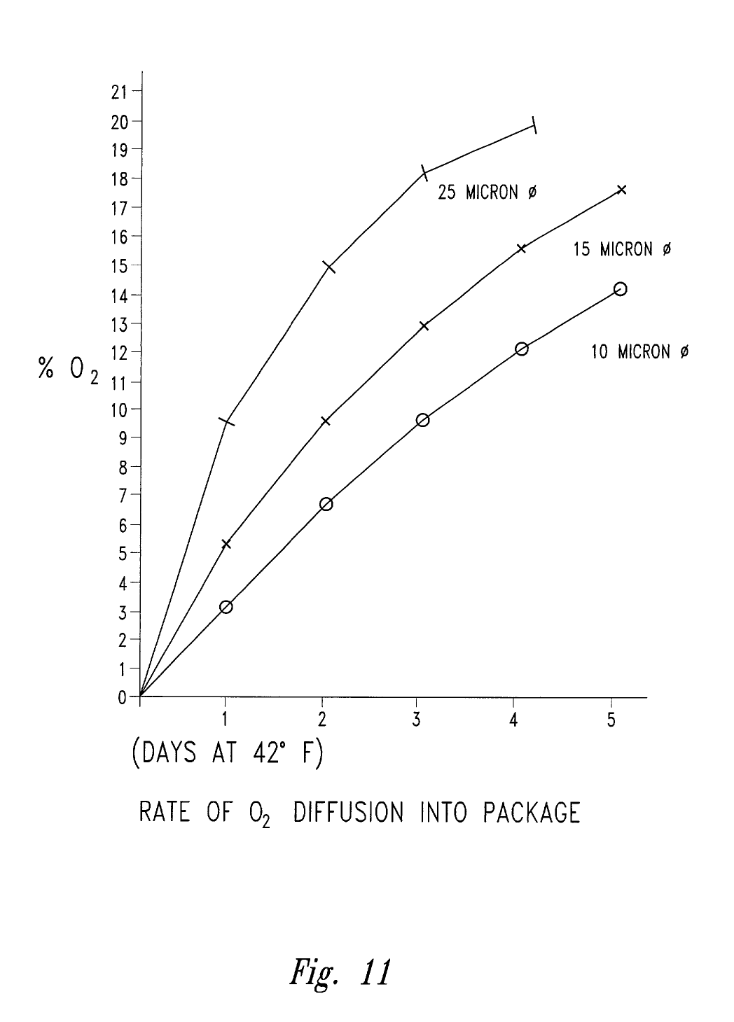

Hence, the rate of O₂ transmission into the package changes downwardly as partial pressure of O₂ diminishes, as shown in FIG. 11.

Other preferred embodiments of the present invention are directed to low oxygen packaging in high barrier containers. In many applications of food packaging, to prevent the proliferation and toxic germination of Clostridium botulinum, it is necessary to maintain a constant minimal level of oxygen in the package. Such applications include meats, meals, and fresh vegetables with high water activity and high pH. In conditions involving the absence of oxygen, these foods may provide conditions for sporulating Clostridium botulinum microorganisms. However, even a relatively low oxygen partial pressure tends to prevent such sporulation, and thus increase safety. But, a relatively high partial pressure of oxygen in the package would cause food oxidation. It is therefore recommended to maintain a constant partial pressure of oxygen for most foods of not less than 1% O₂ and not more than 2% O₂. Furthermore, the presence of a relatively low partial pressure of oxygen in the package will promote the development of spoilage, but innocuous aerobic microorganisms, which develop odor, slime, and other organoleptic detectable characteristics before anaerobic microorganisms reach dangerous levels for the consumption of the food. Accordingly, the presence of the traces of oxygen in the food packages is used for the purpose of inhibiting the development of Clostridium botulinum. At the same time, the presence of the oxygen in the package promotes earlier development of aerobic bacteria as a “tell tale” sign of spoiling food before the odorless and tasteless anaerobes become significant and reach dangerous levels.

The technology developed for controlling the oxygen levels described in the present invention was developed for reduced oxygen packaging of various foods in which the circumstances require safety measures. Such foods include all prepared meals, baked goods, meats, sandwiches, fruits, vegetables, and other foods.

This technology consists of (a) determining the rate of depletion of oxygen in a package containing the food and (b) providing the means to replenish oxygen to make up for this loss, with the ultimate objective of maintaining a constant level of partial pressure of oxygen. The methodology employed is embodied in the present invention.

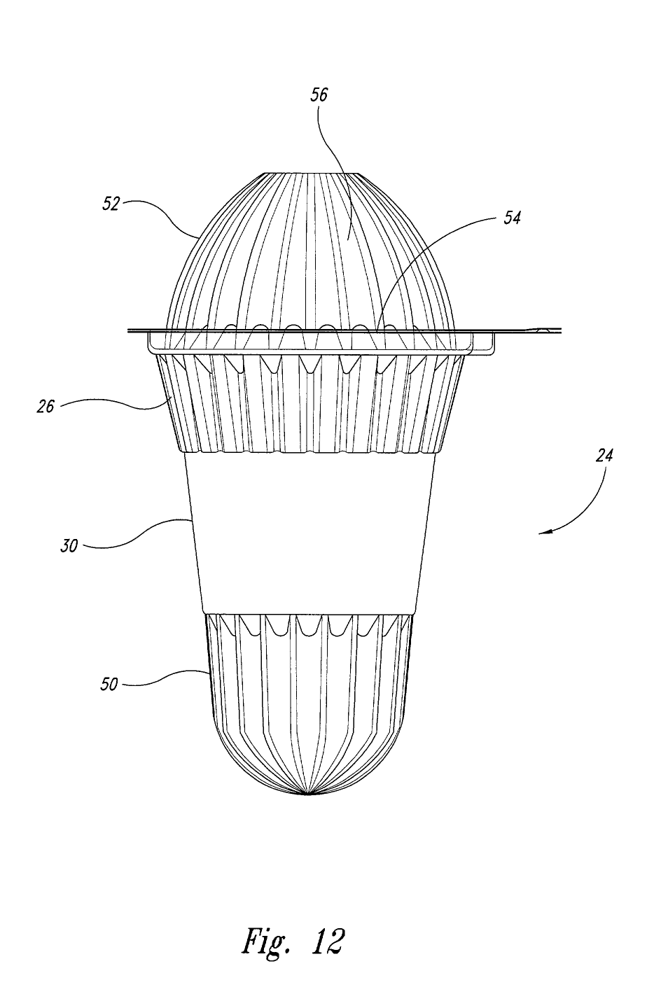

Other embodiments of the single service container of the present invention for extended shelf life are depicted in FIG. 12 hereof.

This embodiment is particularly useful for the purpose of automating the manufacturing of the package with two separate compartments 50,52. One compartment 50 is for the main food ingredient and the other compartment 52 is for the main food additives, such as salt, pepper, dressing, sauces, etc. As it can be appreciated, a membrane 54 is separating the two compartments 50,52. The separation is for the purpose of not allowing the food to contact the individual packs of various “fixings” (i.e., other food items to be intermixed before eating), or it can be used to isolate moist components such as, for example, pickled cucumbers, cooked fruit, or others from contacting the main food.

The container may be displayed with the main food compartment 50 on the top, while the compartment for “fixings” 54 is on the bottom. For consuming, the package is turned around; the package is opened by lifting the opening tab and peeling away the seal, as the seal is tamper evident. Any of the foregoing seals hereof may be used in alternative embodiments. This feature offers added safety to the consumer.

During opening, the membrane is removed by hand and various components in compartment 52 are removed. The removed components can then be added to the main meal in compartment 50, whereupon the compartment 52, after discarding membrane 54 can be used to reclose container generally 24 and a thorough mixing of the main meal with the “fixings” can be achieved by shaking the two joined compartments 50,52. The snap closure utilized may be similar to that depicted in FIG. 2, and in reclosure is drip proof, thus preventing the spilling out of any liquid components.

Accordingly, and in light of the disclosures hereof, various features of the containers and methods of the present invention may include:

(1) Agitator ribs inverted inward to help food mixing during shaking prior to consuming;

(2) Respiration (diffusion) adjustment as described previously;

(3) Optional recessed portion of the container to accommodate a fork and napkin convenience;

(4) Flat bottom for affixing a UPC label and other identification;

(5) A variety of clear and opaque materials for diffusion control or barrier for gases;

(6) Tamper evident seal;

(7) Capability to have one package with two isolated compartments;

(8) Capability to seal a different gas in each compartment;

(9) Capability to package a moisture absorber in compartment No. 2 and control the moisture absorption rate by a properly designed membrane;

(10) Capability to locate an ethylene gas absorber (i.e., “getter”) in compartment 52 and to control the rate of ethylene gas diffusion with a membrane to control the rate of ripening of the fruit; and

(11) Capability to locate an oxygen absorber (O₂ getter) such as ferrous oxide in compartments 50 or 52 and to control the rate of oxygen diffusion into package 24. To control the oxygen transmission into compartment No. 2 with a membrane and ribs design of the rigid container to reach and maintain a desirable oxygen equilibrium for the product packaged in compartment 50.

In some preferred embodiments hereof, the food container cup 50 may be laminated, thermoformed and filled with product per technology disclosed by Redex U.S. Pat. No. 5,632,133.

As for preferred polymeric materials for use in the present invention, the cup 50 and the dome 52 may be made from laminates. High barrier containers are made from thermoformable, laminated poly vinyl chloride, thermoformable polyethylene teraphtalete, polystyrenes, and many other conventional materials laminated by fusing them with coextruded polymer and copolymer films of ethyl vinyl alcohol, polyethylene for sealants and others. The containers of fresh fruits and vegetables may be made from polymeric or copolymeric films with high diffusion rate of gases, of 400-600 cc O₂/24 hours/100 in²/mil/ATM such as styrene butediene copolymer. These sheets are preferably of adhesiveless lamination with modified polyethylene film, which allows that the two halves of the package be sealed hermetically with each other.

The membrane polymeric film consists of a coextrusion of at least two layers of modified polyethylene sealant. The modifiers include ethyl vinyl acetate (EVA), ethyl methyl acrylate (EMA) or other components in ratios of blending commensurate with the degree of peelability of the seals and diffusion characteristics required.

FIG. 12 hereof shows a yet further alternative embodiment having a cup (1) with a hermetically sealed polymeric membrane 54 to cup 50 and a snap in lid (2) in the form of a dome 52.

The cup 50 is made from a variety of polymeric structures such as polyvinyl chloride, polyethylene teraphtalate, styrenes and other rigid sheets adhesiveless fused with a polyolefin sealant compatible in fusing and forming a hermetic seal with the polymeric membrane (3). The walls 30 of the cup contain ribs 26 to prevent the leaves of lettuce and fruits from touching walls 30 and to restrict the circulation of the oxygen.

The lid dome 52 is preferably made from a mono-layer polymeric sheet such as clear polyethylene teraphtalate or others.

The space 56 under the dome is provided for storage of components for the food such as salt, pepper sachets, mayonnaise, catsup, and dressing in small bags.

In order to open package 24 of FIG. 12, the consumer separates the lid dome 52 from cup 50 by pulling apart the tabs (not shown) on the rims (as shown in FIG. 2), and removing dome 52. Membrane 54 then is peeled away and the food is exposed for adding the condiments. Upon adding these components to the food in the cup, the dome 52 is assembled again with cup 50, and the food can be thoroughly mixed by shaking it. The ribs (4) assist in mixing the contents.

From the foregoing it will be appreciated that, although specific embodiments of the invention have been described herein for purposes of illustration, various modifications may be made without deviating from the spirit and scope of the invention. Accordingly, the invention is not limited except as by the appended claims

What is claimed is:

1. A method of maintaining a controlled level of oxygen within a closed food package, said method comprising:
forming at least one package element from a laminate of polymeric films, said laminate having selected oxygen permeability characteristics to maintain oxygen in said package at a level between the oxygen level which will prevent anaerobic microorganisms from developing and an oxygen level sufficient to permit aerobic bacteria to develop and thus indicate spoilage;
disposing a food product within said package; and
closing the package to the outside atmosphere.

2. The method of claim 1 further comprising:
selecting said laminate polymeric films and providing the required surface area of the container to maintain a constant partial pressure of oxygen within said closed package at not less than about 1% O₂ and not more than about 2% O₂ and selecting said laminated polymer films designed to maintain desirable partial pressure of oxygen within said hermetically sealed container.

3. The method of claim 1 further wherein:
said closed package has a defined head space; and
the volume of said head space is selected in combination with said permeability characteristics of said laminate to maintain at a stable selected level said partial pressure of oxygen within said package.

4. The method of claim 1 further comprising:
providing within said container micropores of selected diameter sufficient to permit passage of oxygen therethrough and into said container; and
disposing a polymeric label material over said container micropores said polymeric label material having smaller label micropores therein to control diffusion of oxygen therethrough and to maintain partial oxygen pressure within said closed package at a selected level.

5. The method of claim 4 wherein said label material comprises expanded polypropylene.

6. The method of claim 4 wherein said label material comprises expanded polyethylene.

7. The method of claim 1 further comprising:
providing package surface area increasing means upon said food package elements for increasing the absolute value of oxygen permeability of the closed package.

8. The method of claim 7 wherein said package surface area increasing means comprises ribs disposed upon said package.

9. The method of claim 7 further comprising adjusting the size of said package surface area increasing means to control the effective amount of surface area of said package available for oxygen transmission.

10. The method of claim 7 further comprising lid
providing a food package having container and package elements; and
providing said package surface area means upon said container element of said food package.

11. The method of claim 7 further comprising
providing a food package having container and package elements; and
providing said package surface area means upon said package lid element of said food package.

12. The method of selecting said laminate polymeric films and surfaces to provide O₂ partial pressure to control metabolic for fruits and vegetables.

13. The method of selecting said laminate polymeric films to provide constant O₂ partial pressure measurable in parts per million.

14. The method of claim 7 further comprising:
selecting said laminate polymeric films to maintain a constant partial pressure of oxygen within said closed package at not less than about 1% O₂ and not more than about 2% O₂.

15. The method of claim 7 further wherein:
said closed package has a defined head space; and
the volume of said head space is selected in combination with said permeability characteristics of said laminate to maintain at a stable selected level said partial pressure of oxygen within said package.

16. The method of claim 7 further comprising:
providing within said container micropores of selected diameter sufficient to permit passage of oxygen therethrough and into said container; and
disposing a polymeric label material over said container micropores said polymeric label material having smaller label micropores therein to control diffusion of oxygen therethrough and to maintain partial oxygen pressure within said closed package at a selected level.

17. The method of claim 7 wherein said label material comprises expanded polypropylene.

18. The method of claim 7 wherein said label material comprises expanded polyethylene.

19. The method of claim 4 wherein said container micropores are approximately 25 microns in diameter.

20. The method of claim 4 wherein said smaller label micropores are approximately 5 microns in diameter.

21. The method of claim 1 wherein at least one package element is formed from styrene-butadiene copolymer.

22. The method of claim 1 wherein at least one package element has a gaseous diffusion rate of 400-600 cc O₂/24 hours/100 in²/mil at ATM.

23. The method of claim 8 wherein said ribs stiffen said package element.

24. The method of claim 23 further comprising decreasing the thickness of said package element to control the gaseous permeability characteristics thereof.

25. The method of claim 1 wherein said closed food package comprises container and package lid elements with package closure means disposed therebetween.

26. The method of claim 25 wherein said package closure element comprises a sealable strip.

27. The method of claim 25 wherein said package closure further comprises a flange supporting said sealable strip.

28. The method of claim 25 wherein said package closure means comprises mating male and female members.

29. The method of claim 25 wherein said package lid element comprises a dome.

30. The method of claim 25 wherein said package lid element comprises a dome hermetically sealed with the cup.

31. The method of claim 25 wherein said container element includes an opening thereinto and a closure membrane is sealed thereupon.

32. The method of hermetically sealed cup and dome with headspace filled with CO₂ and N₂ mixture, or N₂ and O₂ mixture, or Ar—CO₂—O₂ mixture.

33. The method of claim 31 further comprising controlling the gaseous diffusion rate of said closure membrane.

34. The method of claim 1 wherein at least one of said package elements has a gaseous diffusion rate of approximately 0.1 cc O₂/24 hours/100 ins²/ATM @ 75° F. and relative humidity of 65%
